(19) United States
(12) Patent Application Publication
(10) Pub. No.: US 2022/0166620 A1
(43) Pub. Date: May 26, 2022

(54) Access Network Facilitated Per Application Instance Secure Communication

(71) Applicant: AT&T Intellectual Property I, L.P., Atlanta, GA (US)

(72) Inventor: Olayinka Oladimeji, Carnation, WA (US)

(21) Appl. No.: 17/100,283

(22) Filed: Nov. 20, 2020

(51) Int. Cl. H04L 9/32; G06F 21/44

(52) U.S. Cl. CPC H04L 9/32; G06F 21/44

(57) ABSTRACT

Secure communication between an application instance and an application server based on the specific application instance and via an access network equipment security component is disclosed. The specific application instance can correspond to a cryptographic requirement and can be required to satisfy corresponding authentication challenge employing a cryptographic profile of the specific application instance, wherein the specific application instance can be uniquely identified. In an aspect, an application instance can capture computing resources to avoid exposing data within a supporting user equipment. Moreover, a network provider can authenticate and authorize the application instance to communicate via a secure tunnel with an application server, wherein the communication can further employ a proprietary transport protocol. The disclosure supports providing heightened data communication security in a manner that is independent of the security features of user equipment hardware or operating systems.

### TECHNICAL FIELD

The disclosed subject matter relates to secure communication to/from an application instance via a network, and more specifically to supporting per application instance secure communication via security measures implemented at access network equipment.

### BACKGROUND

Conventionally, an application instance can communicate data via a network. These communications can often be subject to little to no security, for example, communicating data in the open, in readable text, etc. Even when some security is attempted, this can often be minimally effective against even a moderately sophisticated interferer. As an example, users can sign into a remote website with a username and password that can typically be easily read from an intercepted stream of data between the application instance and the application server. It is also generally desirable that some entities have available higher levels of security for communications, as examples, first responders, users engaged in commerce, etc. Accordingly, improved security communication technologies have been developed, but these systems can often be associated with proprietary hardware, e.g., hardened mobile devices, or other proprietary hardware. Moreover, where proprietary user devices can be expensive or otherwise inconvenient, implementing secure systems on hardware targeted at the general public can be limited to features included in the hardware by the device manufactures. This can lead to situations where effective techniques can be developed and implemented to access private data between manufacturer device iterations, e.g., if a hacker determines how to break the security of a first generation phone, the hack could be effective until a second generation phone is developed and deployed. This can lead to increased costs to keep equipment up to date, apply patches, employ security professionals, and the like.

### BRIEF DESCRIPTION OF DRAWINGS

FIG. 1 is an illustration of an example system that can enable application instance secure communication via an access network, in accordance with aspects of the subject disclosure.

FIG. 2 is an illustration of an example system that can facilitate application instance secure communication via a CUPS access network, in accordance with aspects of the subject disclosure.

FIG. 3 is an illustration of an example system that can enable application instance secure communication based on an updatable cryptographic requirement via an access network in accordance with aspects of the subject disclosure.

FIG. 4 illustrates an example system that can facilitate application instance secure communication via an access network according to the illustrated call flow, in accordance with aspects of the subject disclosure.

FIG. 5 is an illustration of an example system enabling application instance secure communication via an access network according to the illustrated protocol stacks, in accordance with aspects of the subject disclosure.

FIG. 6 is an illustration of an example method that can enable application instance secure communication via an access network, in accordance with aspects of the subject disclosure.

FIG. 7 illustrates an example method facilitating, by an access network, secure communication between an application instance and a private application server via the access network, in accordance with aspects of the subject disclosure.

FIG. 8 illustrates an example method that enables secure communication between an application instance and a private application server via an access network based on the access network determining a cryptographic requirement from cryptographic information stored via the private application server, in accordance with aspects of the subject disclosure.

FIG. 9 depicts an example schematic block diagram of a computing environment with which the disclosed subject matter can interact.

FIG. 10 illustrates an example block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As is noted elsewhere herein, conventional application instances can communicate data via a network with arguably limited security that can be considered minimally effective against even a moderately sophisticated interferer. Convectional user name/password type security can often be rapidly bypassed and can expose network provider users and/or network provider clients to increased risks. Unfortunately, where device manufacturers can shy away from including security technologies that can be excessive for more pedestrian users, this can limit the usefulness of these devices by users that need increased communication security. As an example, it can be challenging for a phone manufacturer to add components to allow for military grade communications security when the majority of users don't need that level of security, however, this also results in users that do need this level of security to finding other devices that do include the improved security components, in short, it is typically not in the best financial interest of a user equipment (UE) manufacturer to provide security in a generally available device when it can be expected that only a few users might demand increased security, meaning that these high security users may need to opt for a more hardened device from a manufacture serving the high security niche.

Moreover, even where a device that implements increase security hardware is available, the level of security can only be improved incrementally, e.g., iterations of a device can attempt to keep ahead of attacks developed against the previous device iteration. As an example, a parcel delivery service (PDS) can purchase a hand held package scanner to facilitate package delivery. The example scanner can communicate with an application server operated by PDS according to the security implemented in the scanner. Where an interferer determines a technique to compromise the scanner security, PDS can be forced to patch or replace all the scanners in order to keep the intruder, or anyone the intruder shares the hack with, out of their system/data. This can be viewed as highly expensive, inconvenient, etc. Accordingly, it can be desirable to shift the security away from proprietary user devices, provide security via a network provider to various customers as a value added service, and to have security implemented on a per application instance level. This can enable the security measures to be more nimble and stronger than conventional solutions provided by consumer-grade UEs, and less bothersome, expensive, risky, etc., for an application provider to implement.

The disclosed subject matter allows for an application instance on a user equipment to initiate a more secure communication session than is typical consumer-grade security, e.g., conventional username and password type security. In an aspect, a network provider can facilitate this more secure communication session via access network equipment. In an embodiment, a network-side application specific security component (NASS) can be implemented in core-network components of an access network. In some embodiments, the NASS can be implemented at an edge of the access network, e.g., at a radio access network (RAN) device, or other edge devices. In some embodiments, the NASS can be implemented in a user-plane component, such as at a customer facility, where an access network employs control plane and user plane separation (CUPS) technology.

In an aspect, a UE can be authenticated to an access network in a conventional manner. This can be associated with identification of the UE user, for example, via an international mobile subscriber identity (IMSI), or other such unique identifier. As is disclosed herein, the NASS, in an embodiment, can enable subsequent authentication of an application instance to an application server, stream server, or other remote device, that is in addition to the UE authenticating to the access network. The authentication to the application server, stream server, or other remote device, can enable more secure communication than is typical of consumer-grade UEs. In addition, the disclosed authentication can be performed independent of the security features of the UE executing an application instance, which can allow the presently disclosed access network facilitated per application instance secure communication to be device and/or operating system (OS) agnostic. In an aspect, decoupling this level of authentication from UE security hardware/software can enable use of advanced secure connections on consumer-grade UEs. This can be highly valued because entities desiring more secure connections than would typically be available on consumer-grade UEs can now have access to those advanced security features and, additionally, device/OS independence can allow for continued use of less secure UEs because the advanced security is independent of the device/OS. As an example, a first responder entity can implement advanced secure connections for communications, such as secure push-to-talk, on a consumer-grade mobile device that would typically not offer such high levels of security off the shelf.

In an aspect, the presently disclosed application instance can capture computing resources, e.g., processor cycles, memory space, disk space, root-network, or other computing resources, from a host, e.g., UE, or other host device. This can avoid allowing other applications, services, etc., of the host from accessing data of the captured computing resources that might otherwise be accessible were the application instance to use shared computing resources, e.g., common memory space, etc. The application instance can, via a user-side application specific security (USASS) component, send to a NASS a request that a secure session be initiated. The NASS can then return a cryptographic requirement to the USASS. In an aspect, the NASS can determine the cryptographic requirement based on an identifier, e.g., IMSI, etc., and a cryptographic database stored at the NASS. In a further aspect, the NASS can populate the cryptographic database based on cryptographic information received from a server-side application specific security (SSASS) component of an application server component (ASC). As an example, where the NASS receives the USASS request, the initiation request can be associated with an IMSI. The NASS can determine if a cryptographic requirement can already be determined based on the IMSI, the initiation request and a current cryptographic database of the NASS, and where it can already be determined, can return the cryptographic requirement to the USASS. However, in this example, where the cryptographic requirement cannot already be determined based on the IMSI, the initiation request and a current cryptographic database of the NASS, the NASS can update the cryptographic data base via communication with a SSASS component. The cryptographic requirement can then be determined based on the example updated cryptographic databased, IMSI, and initiation request. In an aspect the cryptographic requirement can be that the application instance can communicate data subject to a hash selected from a group of hashes, an encryption selected from a group of encryptions, an a authentication selected from a group of authentications, as an example, the cryptographic requirement can be that the application can communicate with some combination of AES 128 or AES 256 processes, Diffie-Hellman>=14, 19, or 20 hashing processes, and SHA 2 or AES-X authentication processes. In an aspect, these process(es), e.g., an AES-128 encryption process, can be algorithm(s), e.g., an AES-128 algorithm. In this example, where the application instance has a cryptographic profile with AES-128, Diffie-Hellman>=14, and SHA2 cipher block chaining, the cryptographic profile of the application instance can satisfy the cryptographic requirement.

The USASS can then determine that the cryptographic requirement is met and can then request authentication and authorization of from the NASS. In response to the authentication and authorization request, the NASS can present the USASS with an authentication challenge. In an aspect, the authentication challenge can be to provide a challenge response employing a cryptographic profile. Returning to the above example, a challenge response can be returned to the NASS from the USASS based on the cryptographic profile with AES-128, Diffie-Hellman>=14, and SHA2 cipher block chaining. The NASS can then determine of a received challenge response is successful before enabling an application-stream to open to the ASC. The application-stream can employ a session key returned by the ASC.

The disclosed subject matter enables highly secure communication of data between an application instance of a UE and an application/server via an application streaming tunnel. In an aspect, this communication can be according to a proprietary transport protocol (PTP). Moreover, the application streaming tunnel can be allowed only where the application instance meets defined parameters, e.g., the cryptographic profile of the application instance must satisfy an updateable cryptographic requirement as evidenced by adequately responding to an authentication challenge. Moreover, the application instance can employ captured computing resources at a UE and the UE can first be authenticated to an access network in a conventional manner. It is noted that the disclosed subject matter therefore does not strictly rely on the security hardware/software of the UE and, as such, the disclosed subject matter can be deployed with nearly any UE and/or OS. It is noted that this device/OS agnosticism can even allow for the use of otherwise less secure (or even unsecured) UEs, such as common consumer-grade UEs, like inexpensive mobile devices that don't natively support heightened security communications. Additionally, even where some interferer develops an exploit for first session under the disclosed subject matter, the SSASS cryptographic information can be updated, such that a USASS-NASS authentication for another session will not be successful. Moreover, a session can be lifetimed, e.g., the session can be torn down after a prescribed time or other indicator, such that a new session will be built according to the updatable SSASS cryptographic information. This aspect can allow the disclosed subject matter to remain nimble such that sessions between an app and a server are secured/built with updated cryptographic requirements at a frequency that is greater than that of being able to determine corresponding exploits, e.g., if the lock can be updated faster than the key can be cut, the lock can remain secure. Further, where the data can be communicated under a PTP, gaining access to the data stream, where even possible for at least the aforementioned reasons, can yield data that can be nearly meaningless because the stream of data can be in a proprietary order complicating extraction of any meaningful information. Moreover, the PTP can also be updated, which can further increase the nimble nature of the presently disclosed access network facilitated per application instance secure communication.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

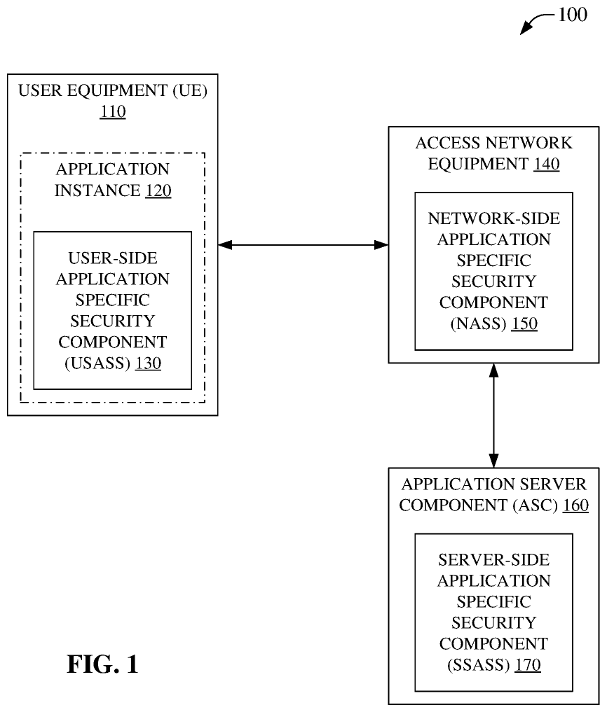

FIG. 1 is an illustration of a system 100, which can facilitate application instance secure communication via an access network, in accordance with aspects of the subject disclosure. System 100 can comprise UE 110, for example, a personal computer, laptop computer, tablet computer, smartphone, internet-of-things (TOT) device, sensor, or other user-side equipment. In an aspect, UE 110 can execute application instance 120. Application instance 120 can correspond to an application-stream, service, or other software or database, executing at a remote device, for example at application server component (ASC) 160. As an example, an application at ASC 160 can be a package delivery database application for PDS, as has been used as an example elsewhere herein. A delivery driver for PDS can have a handheld scanner device that can be represented as UE 110 in system 100. In this example, the handheld scanner can typically communicate, for example via a mobile device access network, with the package delivery database application, for example, to update a record to show that a package has been delivered, etc. It can be desirable that this communication between the example user-side application instance and the server-side application is performed in a secure manner, for example requiring more than just a username and password for the application instance of the handheld scanner to log into the delivery database application of the server.

Accordingly, system 100 can comprise network-side application specific security component (NASS) 150 that can be executing on access network (AN) equipment 140. In an aspect, NASS 150 can be performed by one or more core-network devices of a wired and/or wireless network. In some embodiments, NASS 150 can be implemented at an edge of an access network, e.g., at a radio access network (RAN) device, or other edge devices. In some embodiments, some aspects of NASS 150 can be implemented in a user-plane access network component, such as at a customer facility, while other aspects of NASS 150 can be implemented in a control-plane access network component, where an access network can employ control plane and user plane separation (CUPS) technology.

In an aspect, UE 110 can be authenticated to an access network, e.g., via other components of access network equipment 140, in a conventional manner. This can enable the UE to perform conventional operations via the access network, such as phone calls, text messaging, internet access, or other operations/services. A user of UE 110 can be identified, for example, via an IMSI in a conventional manner, or some other such unique identifier. It is noted that, for the sake of clarity and brevity, an IMSI is used throughout the instant disclosure as a representative example of a user identifier, although the subject disclosure is expressly not limited to use of an IMSI and, in fact, nearly any identifier can be used without departing from the scope of the disclosed subject matter.

Additional authentication and authorization can be performed that is application instance specific. In an embodiment, NASS 150 can enable a subsequent authentication, authorization, or other security services, for application instance 120 to an application server, stream server, or other remote device, e.g., ASC 160, that is in addition to UE 110 conventionally authenticating to a network via access network equipment 140. The additional securing of communications between application instance 120 and an application server, stream server, or other remote device, can enable more secure communication than is typical of a native consumer-grade UE security solution. Moreover, the presently disclosed security measures can be performed independent of, and/or in addition to, the native security features of a UE executing an application instance, and a device and/or operating system (OS) agnostic manner. USASS 130 can interact with NASS 150 to perform the disclosed authentication and authorization. Moreover, NASS 150 can be updated based on SSASS 170, which itself can be updated.

In an aspect, NASS 150 can be populated with a cryptographic requirement corresponding to an application, e.g., a specific application can have a correspondingly specific cryptographic requirement. NASS 150 can be populated via SSASS 170. In an aspect, SSASS 170 can populate NASS 150 at an initial point, then update NASS 150 at a later point. In another aspect, SSASS 170 can populate NASS 150 on-demand, e.g., NASS 150 can request a cryptographic requirement for an application. As an example, NASS 150 can identify an application based on an initial request received from USASS 130, which can cause NASS 150 to request a cryptographic requirement for the identified application from SSASS 170. This can facilitate keeping a cryptographic database of NASS 150 up to date on the fly, to permit security with USASS 130 for application instance 120 to be correspondingly up to date.

In an aspect, computing resources can be captured from UE 110 by application instance 120 upon initiation of application instance 120. As such, application instance 120 can use computing resources that are not typically accessible to other application executing on UE 110, e.g., malicious software on a UE attempting to access information corresponding to application instance 120 can be thwarted by cordoning off computing resources used by application instance 120, for example based on hierarchical permissions, or other access limiting techniques. Computing resources can include, but are not limited to processor time, memory space, disk space, root-network services, or other computing resources. In an aspect, application instance can typically avoid use of shared computing resources to avoid possible points of exploitation, however, in some embodiments, some portion of shared computing resources can be employed where a corresponding risk of exploitation is acceptable.

Application instance 120 can, via USASS 130, send a request that a secure session be initiated to NASS 150. NASS 150 can then return a cryptographic requirement to USASS 130. In an aspect, NASS 150 can determine the cryptographic requirement based on an identifier, e.g., IMSI, or identifier, from a cryptographic database of NASS 150 that can be populated via SSASS 170 as has been disclosed herein. As an example, where NASS 150 receives a USASS 130 initiation request, the initiation request can be associated with an IMSI for a user of UE 110. NASS 150 can determine a cryptographic requirement for application instance 120 from a cryptographic database based on the IMSI. In an aspect, different applications can correspond to different cryptographic requirements. In a further aspect, different identifiers, e.g., IMSIs, etc., can correspond to different cryptographic identifiers. Accordingly, any given application instance 120 can be regarded as unique, e.g., a specific application and a specific user identity, and can therefore correspond with a similarly unique cryptographic requirement, e.g., a specific cryptographic profile for the user identify employing the given application. As an example, an application for tracking dogs called DHunter can be associated with a cryptographic profile. That cryptographic profile can be different for each revision of DHunter, e.g., DHunter 1.0 can have a different cryptographic profile from DHunter 2.0, and so on. Moreover, an example instance of DHunter executing on UE 110, e.g., as application instance 120, can be associated with a user identifier of JSmith, such that the cryptographic profile for the combination of DHunter 2.0 and JSmith can be different from another example cryptographic profile for DHunter 2.0 and MTwain. In an aspect, a cryptographic database at NASS 150 can comprise cryptographic requirements for some, none, or all application instances attempting to authenticate. In an aspect the cryptographic requirement can be that application instance 120 can communicate data subject to a hash selected from a group of hashes, an encryption selected from a group of encryptions, an a authentication selected from a group of authentications, as an example, the cryptographic requirement can be that application instance 120 can communicate with some combination of AES 128 or AES 256, Diffie-Hellman>=14, 19, or 20, and authentication algorithm SHA 2 or AES-X. In this example, where application instance 120 can have a cryptographic profile with AES-128, Diffie-Hellman>=14, and SHA2 cipher block chaining, the cryptographic profile of application instance 120 can satisfy the cryptographic requirement.

USASS 130 can facilitate determining that a cryptographic requirement is satisfied and, in response, can request authentication and authorization, performed according to a cryptographic profile satisfying the cryptographic requirement, from NASS 150. Correspondingly, in response to the authentication and authorization request from USASS 130, NASS 150 can present an authentication challenge that can be satisfied by an appropriate challenge response according to the cryptographic profile that satisfied the cryptographic requirement. In an aspect, the authentication challenge can seek to prove that application instance 120 is employing the correct cryptographic profile and is also correctly responding to the authentication challenge. NASS 150 can then determine if a received challenge response satisfies the authentication challenge. In response to the challenge response satisfying the authentication challenge, an application-stream tunnel to ASC 160 can be initiated to enable communication of data from application instance 120 to ASC 160 via access network equipment 140, wherein the communication I secured by the cryptographic profile that was determined to satisfy the cryptographic requirement, e.g., according to a specified encryption, hash, and authentication corresponding to the cryptographic profile. Moreover, the data communicated can typically be provided in a proprietary transport protocol, which can provide further security in that any data of the stream that may be accessed can be in a transport protocol that can be unique to the communications between an application service and an application instance, which can be in addition to the encryption, hashing, and authentication of the cryptographic profile. Accordingly, system 100 can enable highly secure communication of data between application instance 120 of UE 110 and ASC 160 via an application streaming tunnel facilitated by access network equipment 140.

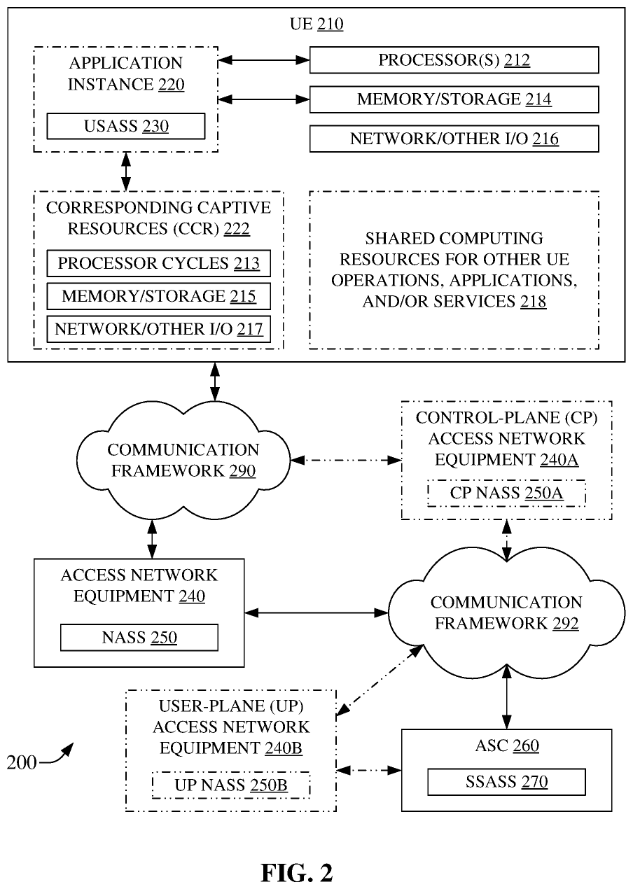

FIG. 2 is an illustration of a system 200, which can enable application instance secure communication via a CUPS access network, in accordance with aspects of the subject disclosure. System 200 can comprise UE 210 that can execute application instance 220. Application instance 220 can correspond to an application-stream, service, or other software or database, executing at a remote device, for example at application server component (ASC) 260. It can be desirable that communication between application instance 220 and ASC 260 be performed in a secure manner, for example requiring more than just a username and password for application instance 220 to log into the ASC 260.

Accordingly, system 200 can comprise NASS 250 that can be executing on access network equipment 240. In an aspect, NASS 250 can be performed by one or more core-network devices of a wired and/or wireless network. In some embodiments, NASS 250 can be implemented at an edge of an access network, e.g., at a radio access network (RAN) device, or other edge devices. In some embodiments, some aspects of NASS 250 can be implemented in user-plane (UP) access network component 240B, e.g., executing UP NASS 250B, such as at a customer facility, while other aspects of NASS 250 can be implemented in control-plane (CP) access network component 240A, e.g., executing UP NASS 250A, where an access network can employ control plane and user plane separation (CUPS) technology. In an aspect, where NASS 250 is implemented in a core-network device or in a CUPS environment, UE 210 can communicate via communication framework 290, which can comprise an edge network such as a RAN network, access point, local area network, or other edge network, that can communicate data from UE 210 to a core-network component, e.g., access network equipment 240, or to a CUPS component, e.g., CP access network equipment 240A, UP access network equipment 240B, or other CUPS components that can be located remotely from core-network components of an access network.

As before, a UE, e.g., UE 210, etc., can be authenticated to an access network in a conventional manner. This can enable the UE to perform conventional operations via the access network, such as phone calls, text messaging, internet access, or other operations/services. A user of UE 210 can be identified, for example, via an IMSI in a conventional manner, or some other such unique identifier. Additional authentication and authorization can be performed that is application instance specific. In an embodiment, NASS 250 can enable a subsequent authentication, authorization, or other security services, for application instance 220 to an application server, stream server, data-lake, or other remote device, e.g., ASC 260, that is in addition to UE 210 conventionally authenticating to a network via access network equipment 240. The additional securing of communications between application instance 220 and an application server, stream server, or other remote device, can enable more secure communication than is typical of a native consumer-grade UE security solution. Moreover, the presently disclosed security measures can be performed independent of, and/or in addition to, the native security features of a UE executing an application instance, and a device and/or OS agnostic manner. USASS 230 can interact with NASS 250, CP NASS 250A, UP NASS 250B, or other NASS components, to perform the disclosed authentication and authorization. Moreover, NASS 250, CP NASS 250A, UP NASS 250B, etc., can be updated based on SSASS 270, which itself can be updatable by an entity corresponding to the application executing on ASC 260.

In an aspect, NASS 250, CP NASS 250A, UP NASS 250B, etc., hereinafter simply NASS 250 for clarity and brevity, can be populated with a cryptographic requirement corresponding to an application, e.g., a specific application can have a correspondingly specific cryptographic requirement. NASS 250 can be populated via SSASS 270. In an aspect, SSASS 270 can populate NASS 250 at an initial point, then update NASS 250 at a later point. In another aspect, SSASS 270 can populate NASS 250 on-demand, e.g., NASS 250 can request a cryptographic requirement for an application.

Application instance 220 can, via USASS 230, send a request that a secure session be initiated to NASS 250. NASS 250 can then return a cryptographic requirement to USASS 230. In an aspect, NASS 250 can determine the cryptographic requirement based on an identifier, e.g., IMSI, or identifier, from a cryptographic database of NASS 250 that can be populated via SSASS 270 as has been disclosed herein. In an embodiment, a cryptographic database can contain a standardized suite of known elements, server defined elements, or other elements. NASS 250 can determine a cryptographic requirement for application instance 220 from a cryptographic database based on the IMSI. In an aspect the cryptographic requirement can require that application instance 220 communicate data subject to a hash selected from a group of hashes, an encryption selected from a group of encryptions, an a authentication selected from a group of authentications, as an example, the cryptographic requirement can be that application instance 220 can communicate with some combination of AES 128 or AES 256, Diffie-Hellman>=14, 19, or 20, and authentication algorithm SHA 2 or AES-X. In this example, where application instance 220 can have a cryptographic profile with AES-128, Diffie-Hellman>=14, and SHA2 cipher block chaining, the cryptographic profile of application instance 220 can satisfy the cryptographic requirement.

USASS 230 can facilitate determining that a cryptographic requirement is satisfied and, in response, can request authentication and authorization, performed according to a cryptographic profile satisfying the cryptographic requirement, from NASS 250. Correspondingly, in response to the authentication and authorization request from USASS 230, NASS 250 can present an authentication challenge that can be satisfied by an appropriate challenge response according to the cryptographic profile that satisfied the cryptographic requirement. In an aspect, the authentication challenge can seek to prove that application instance 220 is employing the correct cryptographic profile and is also correctly responding to the authentication challenge. NASS 250 can then determine if a received challenge response satisfies the authentication challenge. In response to the challenge response satisfying the authentication challenge, an application-stream tunnel to ASC 260 can be initiated to enable communication of data from application instance 220 to ASC 260 via access network equipment 240, wherein the communication is secured by the cryptographic profile that was determined to satisfy the cryptographic requirement, e.g., according to a specified encryption, hash, and authentication corresponding to the cryptographic profile. Moreover, the data communicated can be provided in a proprietary transport protocol, which can provide further security in that any data of the stream that may be accessed can be in a transport protocol that can be unique to the communications between an application service and an application instance, which can be in addition to the encryption, hashing, and authentication of the cryptographic profile. Accordingly, system 200 can enable highly secure communication of data between application instance 220 of UE 210 and ASC 260 via an application streaming tunnel facilitated by access network equipment 240.

In an aspect, computing resources can be captured from UE 210 by application instance 220 upon initiation of application instance 220. As such, application instance 220 can use computing resources that are not typically accessible to other application executing on UE 210, e.g., malicious software on a UE attempting to access information corresponding to application instance 220 can be thwarted by cordoning off computing resources used by application instance 220, for example based on hierarchical permissions, peripheral component interconnect (PCI pass-through type isolation, or other access limiting techniques. Computing resources can include, but are not limited to processor time, memory space, disk space, root-network services, or other computing resources. Accordingly, UE 210 can comprise processor(s) 212, memory/storage 214, network/other input/output (I/O) 216, and other computing resources that can be generally available to programs, applications, services, etc., executing on UE 210, e.g., vie shared computing resources for other UE operations, applications and/or services, 218, that can be distinct from corresponding captive resources (CCR) 222. CCR 222 can be captured at initiation of execution of application instance 220. CCR 222 can comprise captive computing resources, e.g., processor cycles 213, memory/storage 215, network/other I/O 217, etc. In this aspect, CCR 222 can comprise computing resources typically not accessible to other UE operations, applications, and/or services, for example those employing shared computing resources 218. In an aspect, application instance 220 can typically avoid use of shared computing resources, e.g., 218, to avoid possible points of exploitation, however, in some embodiments, some portion of shared computing resources can be employed where a corresponding risk of exploitation is acceptable, as has been noted elsewhere herein.

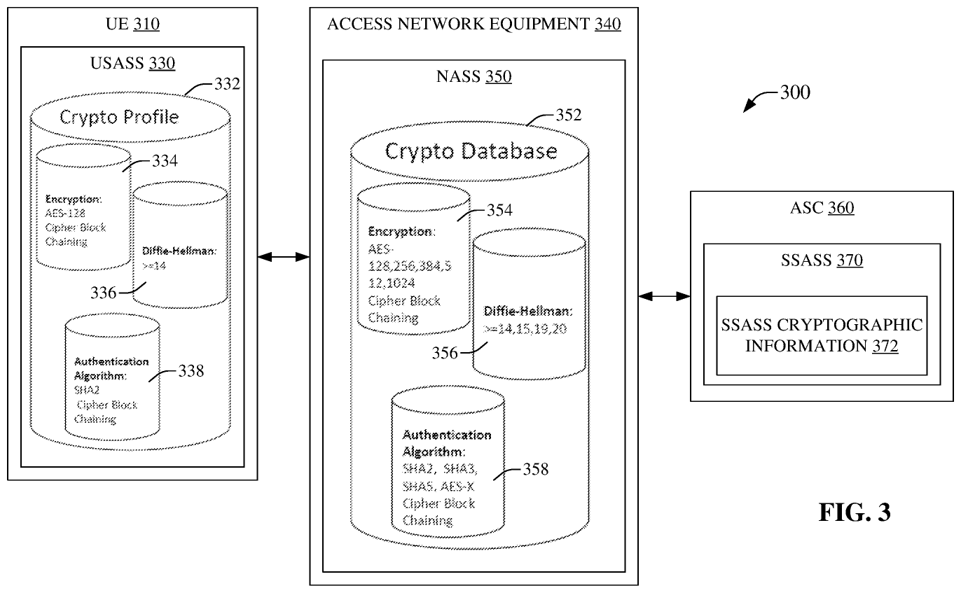

FIG. 3 is an illustration of a system 300 that can facilitate application instance secure communication based on an updatable cryptographic requirement via an access network, in accordance with aspects of the subject disclosure. System 300 can comprise UE 310 that can be in communication with ASC 360 via access network equipment 340 as has been described herein. UE 310 can be authenticated to an access network in a conventional manner as a user of a corresponding access network, e.g., a mobile device can authenticate to a subscriber access network to perform conventional activities, e.g., phone calls, text messaging, internet access, or other operations/services. A user of UE 310 can be identified, for example, via an IMSI in a conventional manner, or some other such unique identifier. Additional authentication and authorization can be performed that is application instance specific, e.g., where an instance of an application initiates communication to an correspondingly enabled ACS, e.t. ACS 360, additional authentication and authorization can be performed to provide increased communication security as has been illustrated elsewhere herein. In an embodiment, access network equipment 340 can comprise NASS 350 that can enable subsequent authentication, authorization, or other security services, for an application instance of UE 310 to communicate with an application server, stream server, or other remote device, e.g., ASC 360, that is in addition to UE 310 conventionally authenticating to a network via access network equipment 340. The additional securing of communications between an application instance of UE 310 and an application server, stream server, or other remote device, can enable more secure communication than is typical of a native consumer-grade UE security solution. Moreover, the presently disclosed security measures can be performed independent of, and/or in addition to, the native security features of a UE executing an application instance, and a device and/or OS agnostic manner. USASS 330 of UE 310 can interact with NASS 350 to perform the disclosed authentication and authorization. Moreover, NASS 350 can be updated based on SSASS cryptographic information 372 via SSASS 370 of ASC 360. SSASS cryptographic information 372 can be updated by an entity corresponding to an application executing on ASC 360, for example, a first responder push to talk application executing on ASC 360 can be administered by an first responder administrator, such that, the first responder administrator can direct updating of SSASS cryptographic information 372 to maintain the improved security disclosed by the instant application. In this example, where a new version of a first responder application is to be deployed, SSASS cryptographic information 372 can be updated to enable instances of this new version executing on UEs like UE 310 to communicate with the server application-stream. Similarly, in this example, where an older version of the first responder application is to be denied access to the server application-stream, SSASS cryptographic information 372 can be correspondingly updated such that future instances of the old first responder application will be unable to access the server application-stream.

In system 300, an application instance can, via USASS 330, send a request to NASS 350, requesting that a secure session be initiated. NASS 350 can then return a cryptographic requirement to USASS 330. In an aspect, NASS 350 can determine the cryptographic requirement based on an identifier, e.g., IMSI, or identifier, and from a cryptographic database 352 of NASS 350 that can be populated via SSASS 370 based on updateable SSASS cryptographic information 372, as has been disclosed herein. As an example, where NASS 350 receives a USASS 330 initiation request, the initiation request can be associated with an IMSI for a user of UE 310. NASS 350 can determine a cryptographic requirement for application instance 320 from cryptographic database 352 based on the IMSI. In an aspect, different applications can correspond to different cryptographic requirements. In a further aspect, different identifiers, e.g., IMSIs, etc., can correspond to different cryptographic identifiers. Accordingly, any given application instance can be regarded as unique, e.g., a specific application and a specific user identity, and can therefore correspond with a similarly unique cryptographic requirement, e.g., a specific cryptographic profile for the user identify employing the given application. In an aspect, cryptographic database 352 can comprise cryptographic requirements for some, none, or all application instances attempting to authenticate to access network equipment 340. In an aspect the cryptographic requirement can be that application instance 320 can communicate data subject to a hash selected from a group of hashes 356, an encryption selected from a group of encryptions 354, and an a authentication selected from a group of authentications 358, as an example, the cryptographic requirement can be that a combination of AES 128 or AES 256, Diffie-Hellman>=14, 19, or 20, and authentication algorithm SHA 2 or AES-X be employed, as has been used in other example elsewhere herein. In this example, where an application instance executing on UE 310 can have a cryptographic profile 332 with AES-128 at 334, Diffie-Hellman>=14 and 336, and SHA2 cipher block chaining at 338, cryptographic profile 332 can satisfy the cryptographic requirement according to USASS 330.

In response to USASS 330 determining that cryptographic profile 332 can satisfy a cryptographic requirement, USASS 330 can communicate a request for authentication and authorization to NASS 350, e.g., USASS 330 can determines that cryptographic profile 332 meets the cryptographic requirements based on cryptographic database 352 before advancing the authentication and authorization process. Where NASS 350 then receives this request to continue, e.g., the request for authentication and authorization, NASS 350 can present an authentication challenge to USASS 330. The authentication challenge can be satisfied by an appropriate challenge response communicated from USASS 330, back to NASS 350, according to cryptographic profile 332. In an aspect, the authentication challenge can seek to prove that a correct cryptographic profile, e.g., cryptographic profile 332, is being employed in correctly responding to the authentication challenge. NASS 350, in response to the challenge response satisfying the authentication challenge, can initiate an application-stream tunnel to ASC 360 to enable data from a corresponding application instance to be communicated to ASC 360 via access network equipment 340. This communication can be secured cryptography indicated in cryptographic profile 332, e.g., according to encryption 334, hash 336, and authentication 338 of cryptographic profile 332. Moreover, the data communicated via this tunnel can typically be provided in a proprietary transport protocol that can provide further security as is disclosed elsewhere herein. Accordingly, system 300 can enable highly secure communication of data between an application instance of UE 310 and ASC 360 via an application streaming tunnel facilitated by access network equipment 340, wherein the tunnel is conditional on cryptographic profile 332 satisfying a cryptographic requirement corresponding to the application instance and IMSI of a user of UE 310.

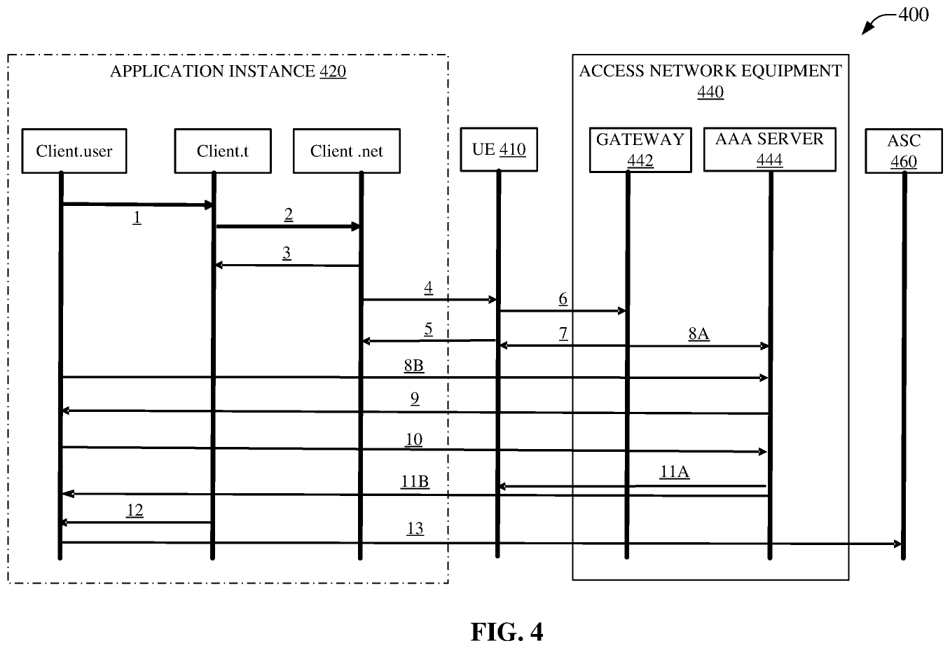

FIG. 4 is an illustration of a system 400, which can enable application instance secure communication via an access network according to the illustrated call flow, in accordance with aspects of the subject disclosure. System 400 can comprise UE 410 that can establish communication with ASC 460 via access network equipment 440, as has been described herein. Application instance 420 can be instantiated on UE 410. Application instance 420, on launch, can capture a fraction of CPU, memory, disk and root-network, and other computing resources from a host, e.g., a mobile phone, tablet, IOT node, or other host, as disclosed elsewhere herein. In an aspect, this can isolate application instance 420 from dictates of a physical eco-system of the host and can accelerate input/output through fast-paths of a OS common user space. In an aspect, this can result in a building block-like development framework for instances of proprietary applications that can be broadly distributed and can execute on comparatively inexpensive readily available consumer-grade hardware/OS, while still providing enterprise-level security, telecom-grade authentication, and full network access.

At arrow 1, a user object of a Client class of system 400, e.g., Clinet.user, can launch application instance 420 and can initiate access towards ASC 460 via a request to client.t. At arrow 2, a request for a transport path using an application instance defined protocol, ‘#p’, can be triggered to a client.net object, for example, the protocol can be IPSec, IKE, ESP, or any other proprietary protocol. A response to the client.t transport path setup request can be returned to the Client.t object at arrow 3.

At arrow 4, the client.net object can use the OS user space to send raw input/output data transfers to/from the aforementioned captured UE network interface computing resources, subject to encapsulation according to the defined protocol #p, e.g., as proprietary transport protocol (#ptp) packets. This can be the first exposure of the data outside of application instance 420, e.g., #ptp.packets can be encapsulated by application instance 420 to be sent to UE 410. At arrow 5, UE 410 can use an OS user space pass through technique to respond to data transfers to/from app client.net. UE 410, at arrow 6, can create an http session with gateway 442 of access network equipment 440. This http session can transport the encapsulated client packets to/from client/net object, e.g., at arrow 4, etc. This http session can contain a session/stream initiation request from client.user that can be directed towards AAA 444 at a later point. At arrow 7, gateway 442 can start initiation of a cryptographic suite exchange and can determine continuation of the illustrated call set-up, e.g., a cryptographic requirement, as disclosed elsewhere herein, can be sent to UE 410 at arrow 7. The HTTPS return session of the encapsulated client packet can occur at 11A.

Where the cryptographic requirement is determined to be satisfied by a cryptographic profile of application instance 420, at arrow 8A, a multi-round diameter authentication request to AAA server 444 can occur to authenticate UE 410 to the access network comprising access network equipment 440. At arrow 8B, a multi-round diameter authentication request to AAA server 444 can occur to authenticate client.user of application instance 420. Arrow 8B can result in AAA server 444 issuing a EAP-AKA Authentication challenge towards client.user at arrow 9. Accordingly, at arrow 10, the client.user object can respond with requested challenge attributes, as is disclosed elsewhere herein. AAA server 444 can demine that the challenge attributes from arrow 10 can satisfy the authentication challenge from arrow 9 and, at arrow 11B, AAA server 444 can indicate that the EAP-AKA challenge has been completed successfully. At arrow 12, ASC 460 can return a session.stream.key to the client.t, which can trigger a user-plane tunnel to application instance 420. This tunnel can enable secure interaction with ASC 460 at arrow 13.

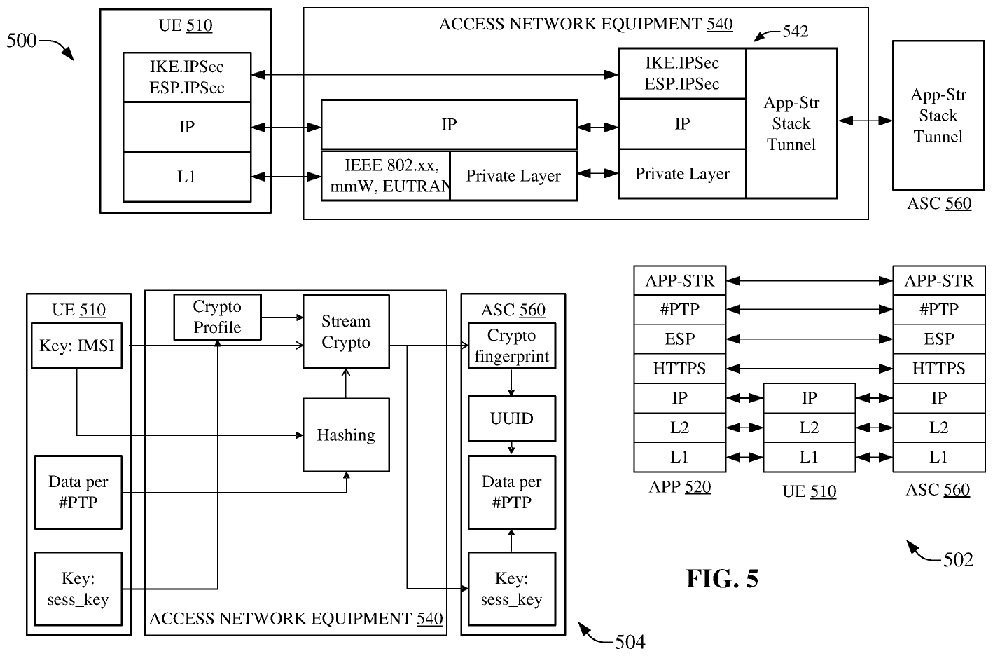

FIG. 5 is an illustration of an example system 500 that can facilitate application instance secure communication via an access network according to the illustrated protocol stacks, in accordance with aspects of the subject disclosure. System 500 can comprise UE 510 in communication with access network equipment 540 that can be in communication with ASC 560. System 500 can be illustrative of protocol stack arrangements among the various components. As can be observed, the L1 layer of UE 510 can be coupled to the radio layer of a first component of access network equipment 540. System 500 further illustrates that the IP layers of UE 510 and the first component of the access network equipment 540 can be coupled. The IP layers of the first component of the access network equipment 540 and an IP layer of a gateway component 542, e.g., gateway 442, etc., can be coupled. Moreover, the IKE and ESP portions of an IPSec layer for UE 510 can be coupled to gateway component 542. Accordingly, gateway 542 can be couple to ASC 560 via corresponding App-Str stack tunnel layers where the tunnel, as disclosed elsewhere herein is successfully instantiated. In an aspect, the IKE and ESP portions of the IPSec layer can be separated into a user-plane and control-plane such that the IKE.IPSec UE control-plane layers of the protocol stack are coupled and the ESP.IPSec UE user-plane layers of the protocol stack are coupled. This can facilitate CUPS access network topologies, as will be readily appreciated.

At 502, an example protocol stack between an application instance, e.g., APP 520, and ASC 560 via UE 510 can be illustrated. The L1, L2, and IP layers of APP 5210, UE 510, and ASC 560 can be coupled, as illustrated. Moreover, at 502, the HTTPS layer of ASC 560 and APP 520 can be coupled. Similarly, the ESP, #PTP , and APP-STR layers of ASC 560 and APP 520 can be coupled. Accordingly, app data can be streamed subject to a proprietary transport protocol, in an encapsulated packet via HTTPS.

At 504, a session key, e.g., sess_key, can be employed to select a cryptographic profile that can be employed to encrypt a hash of data secured according to a proprietary transport protocol and an IMSI. The data IMSI and session key can be sent from UE 510 to access network equipment 540 for encryption, as illustrated. Encrypted data can be communicated to ASC 560. At ASC 560, the session key can be decoded and a cryptographic fingerprint can be determined from the encrypted data, the cryptographic fingerprint, sess_key, and a unique use identity (UUID), for example the IMSI, can be used to decrypt the encrypted data into the proprietary transport protocol form, which can be readable to ASC 560.

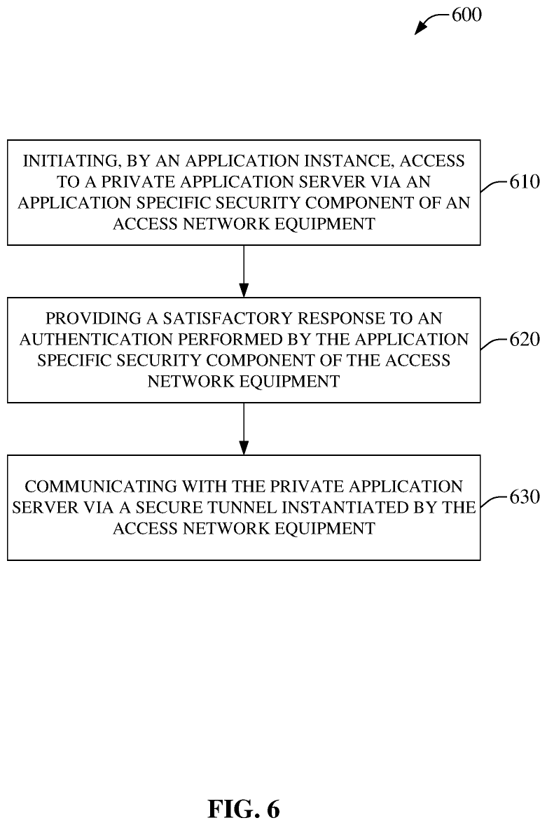

In view of the example system(s) described above, example method(s) that can be implemented in accordance with the disclosed subject matter can be better appreciated with reference to flowcharts in FIG. 6-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternately be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 is an illustration of an example method 600, which can enable an application instance to initiate secure communication via an access network, in accordance with aspects of the subject disclosure. At 610, method 600 can comprise initiating, by an application instance, access to a private application server via an application specific security component of access network equipment. In an aspect, a UE can execute the application instance. The application instance can execute on a user-side and can correspond to an application, stream, service, or other software or database, executing at a remote device, for example at an ASC. It can be desirable that communication between the application instance and the ASC is performed in a secure manner, for example requiring more than just a username and password for the application instance of the handheld scanner to log into the delivery database application of the server. Accordingly, the application instance can initiate secure communication to the ASC, which can be via a security component, e.g., NASS 150, 250, 350, etc., implemented on access network equipment, for example, a core-network device of an access network. This can enable the security component to perform authentication and authorization on behalf of the ASC, offloading this task from the client supporting the application at the ASC.

Method 600, at 620, can comprise providing a satisfactory response to an application specific authentication performed by the application specific security component of the access network equipment, e.g., NASS 150, 250, 350, etc. Application specific authentication by a NASS can comprise determining that the application instance can fulfill a cryptographic requirement, e.g., that the application instance can employ appropriate encryption, authentication, and hashing, as well determining that the application instance is appropriately responding to authentication challenges prior to the NASS enabling application instance access to the ASC via a secure tunnel comporting with the cryptographic requirements. Accordingly, the application instance must provide satisfactory responses to the application specific authentication interactions to avoid the access network terminating the authentication and authorization process. In an aspect, establishing a security association (SA) can result from providing a satisfactory response to an authentication challenge.

At 630, method 600 can comprise, communicating with the private application server via a secure tunnel instantiated by the access network equipment. At this point method 600 can end. Where the authentication and authorization of the application instance is deemed satisfactory by the access network equipment, the application instance can be allowed to communicate to a corresponding server-side application executing on the ASC via a secure tunnel provided by the access network equipment.

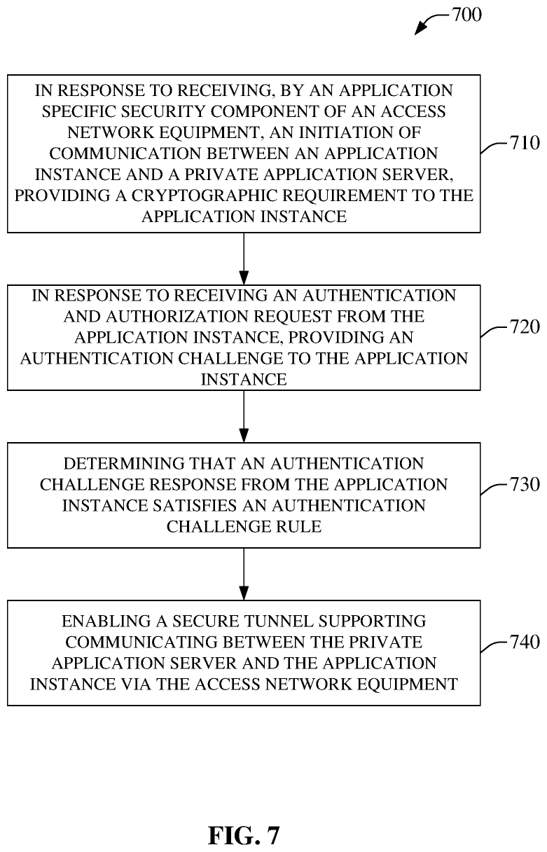

FIG. 7 illustrates example method 700 facilitating, by an access network, secure communication between an application instance and a private application server via the access network, in accordance with aspects of the subject disclosure. Method 700, at 710, can comprise providing a cryptographic requirement to an application instance. Providing the cryptographic requirement to the application instance can be in response to receiving, by an application specific security component of access network equipment, an initiation of communication between the application instance and a private application server. In an aspect, a UE can execute the application instance. The application instance can execute on a user-side and can correspond to an application, stream, service, or other software or database, executing at a remote device, for example at an ASC. It can be desirable that communication between the application instance and the ASC is performed in a secure manner. Accordingly, in response to an application instance initiating secure communication to the ASC, a security component, e.g., NASS 150, 250, 350, etc., implemented on access network equipment, can indicate a cryptographic requirement to the application instance. The application instance can then determine if it can satisfy the cryptographic. Where it cannot, the process can terminate, however, where the application instance can satisfy the cryptographic requirement, an authentication and authorization request can be advanced to the NASS of the access network equipment. In an embodiment, the cryptographic requirement can indicate that the application instance can communicate data subject to a hash selected from a group of hashes, an encryption selected from a group of encryptions, and an a authentication selected from a group of authentications. An example cryptographic requirement, as is recited hereinabove, can be that application instance can communicate with some combination of AES 128 or AES 256 encryption, by hashing with Diffie-Hellman>=14, 19, or 20, and a SHA 2 or AES-X authentication algorithm. In this example, where the application instance can have a cryptographic profile with AES-128, Diffie-Hellman>=14, and SHA2 cipher block chaining, the cryptographic profile of the application instance can be understood to satisfy the example cryptographic requirement.

At 720, method 700 can comprise providing an authentication challenge to the application instance in response to receiving, from the application instance, an authentication and authorization request. NASS can, in response to the authentication and authorization request, indicating that a cryptographic profile of the application instance can satisfy the cryptographic requirement, communicate an authentication challenge that the application instance must satisfactorily respond to avoid terminating the initiation of secure communication to the ASC. The application instance can be expected to return to the NASS a challenge response generated according to the cryptographic profile of the application instance.

Method 700, at 730, can comprise determining that an authentication challenge response from the application instance satisfies an authentication challenge rule. Where the application instance provides a satisfactory authentication challenge response, the cryptographic profile can be understood to satisfy the cryptographic requirements as well as satisfying authentication parameters. This can be because the challenge response can be generated according to the cryptographic profile and that the response can comprise the correct response.

At 740, method 700 can comprise enabling a secure tunnel supporting communicating between the private application server and the application instance via the access network equipment. At this point method 700 can end. Where the authentication and authorization of the application instance is deemed satisfactory by the access network equipment, the application instance can be allowed to communicate to a corresponding server-side application executing on the ASC via a secure tunnel provided by the access network equipment.

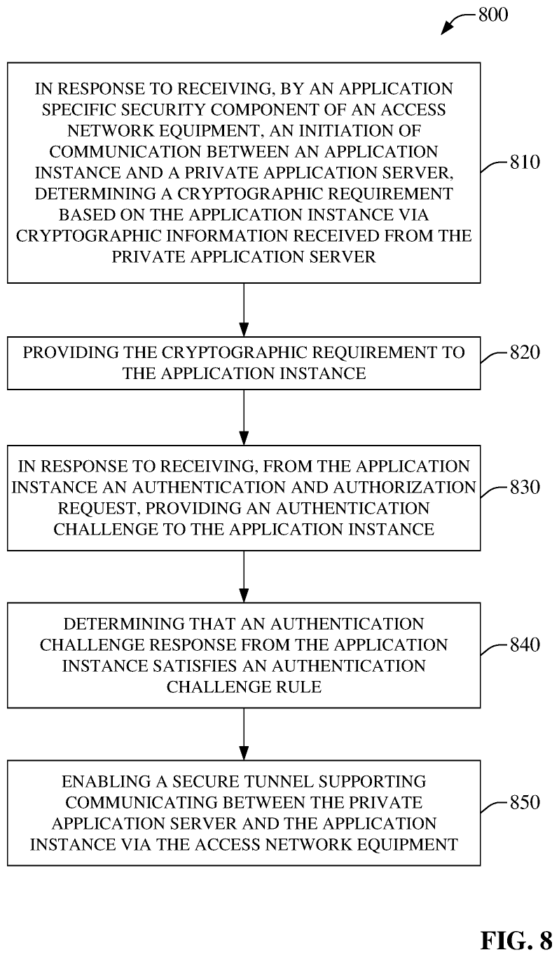

FIG. 8 illustrates example method 800, enabling secure communication between an application instance and a private application server via an access network based on the access network determining a cryptographic requirement from cryptographic information stored via the private application server, in accordance with aspects of the subject disclosure. Method 800, at 810, can comprise determining a cryptographic requirement based on an application instance via cryptographic information received from a private application server. The determining the cryptographic requirement based on the application instance can be in response to receiving, by an application specific security component of access network equipment, an initiation of communication between the application instance and the private application server. In an aspect, a UE can execute the application instance. The application instance can execute on a user-side and can correspond to an application, stream, service, or other software or database, executing at a remote device, for example at an ASC. It can be desirable that communication between the application instance and the ASC is performed in a secure manner. Accordingly, in response to an application instance initiating secure communication to the ASC, a security component, e.g., NASS 150, 250, 350, etc., implemented on access network equipment, can seek to determine an appropriate cryptographic requirement for the specific application instance. As such, the NASS can query cryptographic information stored at the ASC. The cryptographic information stored at the ASC can be updated by server administrators and can reflect a most up to date cryptographic requirement for an application instance. This information can be employed by the NASS to determine an application specific cryptographic requirement.

At 820, method 800 can comprise providing the cryptographic requirement to the application instance. Providing the application specific cryptographic requirement to the application instance can allow the application instance to then determine if it can satisfy the cryptographic requirement. Where it cannot, the process can terminate, however, where the application instance can satisfy the cryptographic requirement, an authentication and authorization request can then be advanced to the NASS of the access network equipment.

At 830, method 800 can comprise providing an authentication challenge to the application instance in response to receiving, from the application instance an authentication and authorization request. In response to the authentication and authorization request being received by the NASS, which can indicate that the application instance has determined that a cryptographic profile of the application instance can satisfy the cryptographic requirement, the NASS can then communicate an authentication challenge that the application instance must satisfactorily respond to avoid terminating the initiation of secure communication to the ASC. The application instance can be expected to return a challenge response to the NASS.

At 840, method 800 can comprise determining that an authentication challenge response from the application instance satisfies an authentication challenge rule. Where the application instance provides a satisfactory authentication challenge response, the cryptographic profile can be understood to satisfy the cryptographic requirements as well as satisfying authentication parameters. This can be because the challenge response can be generated according to the cryptographic profile and that the response can comprise the correct response.

At 850, method 800 can comprise enabling a secure tunnel supporting communicating between the private application server and the application instance via the access network equipment. At this point method 800 can end. Where the authentication and authorization of the application instance is deemed satisfactory by the access network equipment, the application instance can be allowed to communicate to a corresponding server-side application executing on the ASC via a secure tunnel provided by the access network equipment.

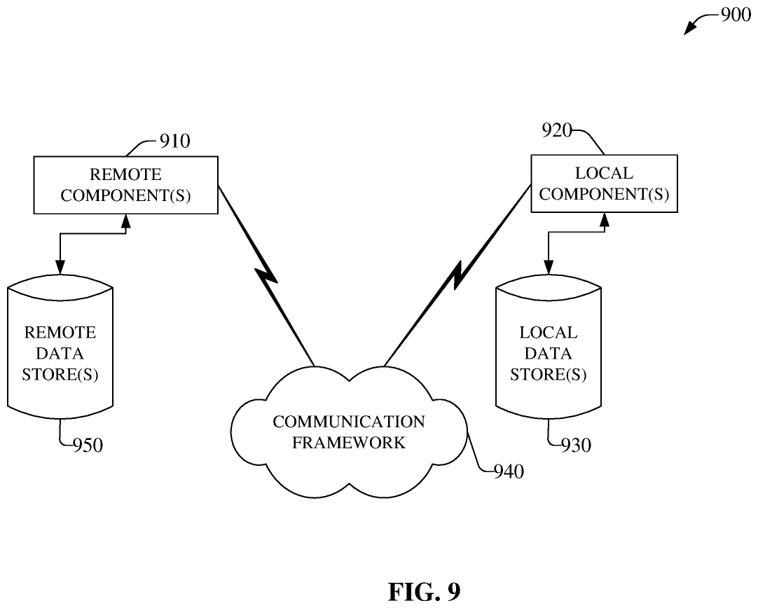

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can comprise UE 110, 210, 310, 410, 510, etc., ASC 160, 260, 360, 460, 560, etc., UP access network equipment 240B, etc., or other components located remotely from access network equipment.

The system 900 also comprises one or more local component(s) 920. The local component(s) 920 can be hardware and/or software (e.g., threads, processes, computing devices). In some embodiments, local component(s) 920 can comprise access network equipment 140, 240, 340, 440, 540, etc., CP access network equipment 240A, gateway 442, 542, etc., AAA server 444, etc., or other component located local to located access network equipment.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. As an example, SINR determination component 120 can store SINR prediction model(s), SINR determination model(s), SINR value(s), current or historical channel characteristic(s), current or historical environmental feature(s)/condition(s)/event(s), etc. Similarly, local component(s) 920 can be operably connected to one or more local data store(s) 930, that can be employed to store information on the local component(s) 920 side of communication framework 940. As an example, RAN 110 can store current or historical channel characteristic(s), current or historical environmental feature(s)/condition(s)/event(s), etc.

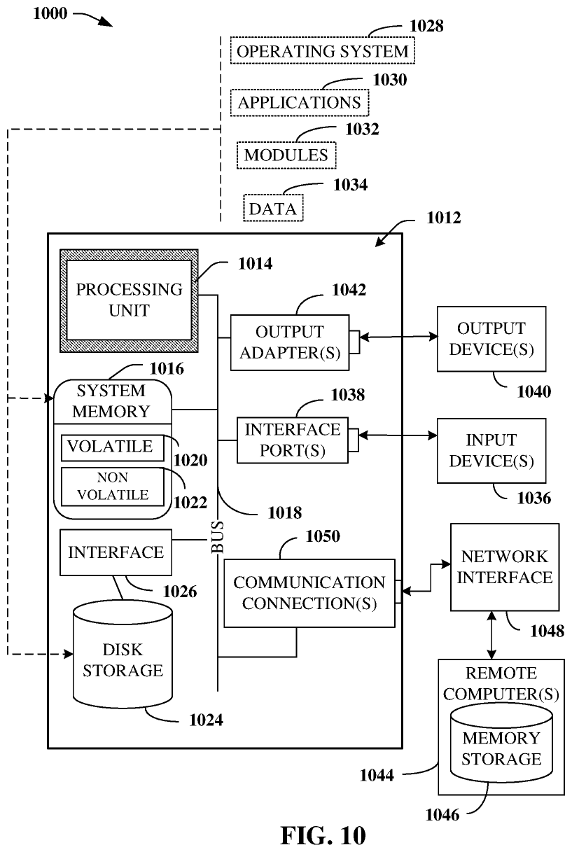

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), single board computers, microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, comprised in UE 110-510, etc., access network equipment 140-540, etc., application server component 160-560, etc., or nearly any other device, can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can comprise volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium. As such, for example, a computer-readable medium can comprise executable instructions stored thereon that, in response to execution, can cause a system comprising a processor to perform operations, comprising authenticating the application instance based on an identity of an application instance in response to an access network equipment receiving an initiation of a secure communication session between the application instance and an application server, wherein the application instance executes on a user equipment, wherein the application instance employs a cryptographic profile that satisfies a cryptographic requirement, and wherein the authenticating determines that a response to a authentication challenge is both satisfactory and was communicated in accord with the cryptographic profile. The operations can further comprise establishing a communication tunnel facilitating secure communication between the application instance and the application server in accord with the cryptographic profile of the application instance, e.g., where the application instance is authenticated and authorized.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command line controlled interface, etc., allowing a user to interact with computer 1012. Input devices 1036 comprise, but are not limited to, a pointing device such as a mouse, trackball, stylus, touch pad, keyboard, microphone or other human voice sensor, accelerometer, biomentric sensor, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial bus port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud-computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring and the like. Wide area network technologies comprise, but are not limited to, point-to-point links, circuit-switching networks like integrated services digital networks and variations thereon, packet switching networks, and digital subscriber lines. As noted elsewhere herein, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A and a second embodiment that has aspect B does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “eNodeB,” “home Node B,” “home access point,” “5G network radio,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can comprise packetized or frame-based flows. Data or signal information exchange can comprise technology, such as, single user (SU) multiple-input and multiple-output (MIMO) (SU MIMO) radio(s), multiple user (MU) MIMO (MU MIMO) radio(s), long-term evolution (LTE), LTE time-division duplexing (TDD), global system for mobile communications (GSM), GSM EDGE Radio Access Network (GERAN), Wi Fi, WLAN, WiMax, CDMA2000, LTE new radio-access technology (LTE-NX), massive MIMO systems, etc.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio access network. Authentication can refer to authenticating a user-identity to a user-account. Authentication can, in some embodiments, refer to determining whether a user-identity requesting a service from a telecom network is authorized to do so within the network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to as extremely high frequency (EHF) waves. The wavelength (λ) for millimeter waves is typically in the 1-mm to 10-mm range.

The term “infer” or “inference” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A device, comprising:
a processor; and
a memory that stores executable instructions that, when executed by the processor, facilitate performance of operations comprising:
receiving, from an application instance executing on a user equipment, an initiation of a secure communication session with an application server;
performing an authentication of the application instance based on a cryptographic requirement and a cryptographic profile, wherein the cryptographic requirement is determined from cryptographic information received from the application server, and wherein the cryptographic profile corresponds to an identification of the application instance; and
facilitating secure communication between the application instance and the application server based on the cryptographic profile of the application instance.

2. The device of claim 1, wherein the communication between the application instance and the application server is according to a proprietary transport protocol.

3. The device of claim 1, wherein performing the authentication of the application instance comprises determining a cryptographic requirement for the application instance.

4. The device of claim 3, wherein determining the cryptographic requirement for the application instance is based on cryptographic database stored at an access network device.

5. The device of claim 3, wherein determining the cryptographic requirement for the application instance is based on cryptographic information received from the application server.

6. The device of claim 5, wherein the cryptographic information received from the application server is employed to update a cryptographic database stored at an access network device.

7. The device of claim 1, wherein the device is comprised in core-network equipment that is part of the access network, and wherein the core-network equipment is located remotely from the user equipment and is located remotely from the application server.

8. The device of claim 1, wherein the device is comprised in edge-network equipment that is part of the access network, and wherein the edge-network equipment is located remotely from core-network equipment of the access network, is located remotely from the user equipment, and is located remotely from the application server.

9. The device of claim 1, wherein the device is comprised of user-plane network equipment and control-plane network equipment that are part of the access network, wherein the access network employs control-plane and user-plane separation topology, and wherein the control-plane network equipment is located remotely from the user equipment and is located remotely from the application server.

10. The device of claim 9, wherein the user-plane network equipment is located remotely from the application server.

11. The device of claim 9, wherein the user-plane network equipment is located remotely from the user equipment.

12. The device of claim 1, wherein the application instance captures computing resources of the user equipment enabling execution of the application in a manner that limits access to application instance data by other applications executing on the user equipment.

13. The device of claim 1, wherein the cryptographic profile identifies a combination of a hash process, an encryption process, and an authentication process.

14. The device of claim 1, wherein the cryptographic requirement identifies a combination of one or more hash processes, one or more encryption processes, and one or more authentication processes.

15. A method, comprising:
receiving, by access network equipment comprising a processor, an initiation of a secure communication session between an application instance and an application server, wherein the application instance is uniquely identifiable, and wherein the application instance executes on a user equipment;
communicating, by the access network equipment to the applicant instance, a cryptographic requirement based on an identification of the application instance, wherein the communicating enables the application instance to determine whether a cryptographic profile of the application instance satisfies the cryptographic requirement;
presenting, by the access network equipment, an authentication challenge to the application instance in response to receiving an authentication request from the application instance;
determining, by the access network equipment, that an authentication challenge response received from the application instance satisfies a first rule related to the application instance properly employing the cryptographic profile to communicate the authentication challenge response;
determining, by the access network equipment, that the authentication challenge response received from the application instance satisfies a second rule related to the authentication challenge response satisfying the authentication challenge; and
instantiating, by the access network equipment, a communication tunnel facilitating secure communication between the application instance and the application server in accord with the cryptographic profile of the application instance and the identification of the application instance.

16. The method of claim 15, wherein communicating the cryptographic requirement comprises determining one or more encryption process, one or more hash process, and one or more authentication process that correspond to an identity of the application instance.

17. The method of claim 16, wherein determining the one or more encryption processes comprises the access network equipment querying cryptographic information stored by the application server based on the identity of the application instance.

18. A non-transitory machine-readable medium, comprising executable instructions that, when executed by a processor, facilitate performance of operations, comprising:
in response to an access network equipment receiving an initiation of a secure communication session between an application instance and an application server, authenticating the application instance based on an identity of the application instance, wherein the application instance executes on a user equipment, wherein the application instance employs a cryptographic profile that satisfies a cryptographic requirement, and wherein the authenticating determines that a response to a authentication challenge is both satisfactory and was communicated in accord with the cryptographic profile; and
establishing a communication tunnel facilitating secure communication between the application instance and the application server in accord with the cryptographic profile of the application instance.

19. The non-transitory machine-readable medium of claim 18, wherein the secure communication, between the application instance and the application server, employs a proprietary transport protocol.

20. The non-transitory machine-readable medium of claim 18, wherein the access network equipment determines an updateable cryptographic database correlated to application instance identities to enable determining a cryptographic requirement that, when communicated to an application instance, enable the application instance to determine whether the cryptographic profile satisfies the cryptographic requirement.
